(19) United States
(12) Patent Application Publication
(10) Pub. No.: US 2022/0025184 A1
(43) Pub. Date: Jan. 27, 2022

(54) DOUGH-LIKE PLAY COMPOUNDS, KITS, AND METHODS OF MAKING AND USING THE SAME

(71) Applicant: WeCool Toys Inc., Point Pleasant, NJ (US)

(72) Inventors: Jeffrey Osnato, Medford, NJ (US); Dexter Williams, Medford, NJ (US)

(21) Appl. No.: 17/443,238

(22) Filed: Jul. 22, 2021

Related U.S. Application Data
(60) Provisional application No. 62/705,906, filed on Jul. 22, 2020.
(60) Provisional application No. 62/706,406, filed on Aug. 14, 2020.

(51) Int. Cl. C08L 99/00; C08L 3/02; A63H 33/00

(52) U.S. Cl. CPC C08L 99/00; C08L 2207/322; A63H 33/001; C08L 3/02

(57) ABSTRACT

The present disclosure relates generally to compositions which form a dough-like moldable play compound when combined with a solvent, as well as kits, and methods of making and using the same. More particularly, it relates to compositions, kits, and methods of making and using a powder composition which forms a dough-like moldable play compound with a solvent. In a preferred embodiment, the solvent comprises water.

### CROSS-REFERENCE TO RELATED APPLICATIONS

This application claims priority under 35 U.S.C. § 119 to provisional applications U.S. Ser. No. 62/705,906, filed Jul. 22, 2020, and U.S. Ser. No. 62/706,406, filed Aug. 14, 2020, herein incorporated by reference in their entirety.

### TECHNICAL FIELD

This disclosure relates generally to compositions which form a dough-like moldable play compound when combined with a solvent, as well as kits, and methods of making and using the same. More particularly, it relates to compositions, kits, and methods of making and using a powder composition which forms a dough-like moldable play compound with a solvent.

### BACKGROUND

The background description provided herein is for the purpose of generally presenting the context of the present disclosure. Work of the presently named inventors, to the extent the work is described in the present disclosure, as well as aspects of the description that may not otherwise qualify as prior art at the time of filing, are neither expressly nor impliedly admitted as prior art.

Toys provide children with the opportunity to learn, engage the senses, spark imagination, and encourage interaction with others. It is often a challenge for toy developers to design a collection which can be used for a purpose other than simply collecting the item itself. Toys can provide additional purposes such as stimulating the child's senses while the child is playing with the toy collection or challenging the child's aptitude for continued learning. For example, water balloons and water bombs are toys which can stimulate a child's senses and engage the child's aptitude for continued learning while the child is playing with the toy, however, the child is left with nothing to collect after a water balloon war but latex rubber that must be discarded in the trash. In another example, trading cards are collectable toys which are limited in their ability to stimulate a child's senses during play. In yet another example, dolls are collectable toys which are limited in their ability to challenge the child's aptitude for continued learning.

However, moldable play compounds provide children with the added benefits of stimulating a child's senses while the child is playing with the toy and challenging the child's aptitude for continued learning. Traditional moldable play compounds include starch and water-based doughs. However, starch and water-based doughs have several disadvantages for use as a modeling compound. Starch and water-based doughs usually exhibit poor plasticity and substantial shrinking upon drying. Among other disadvantages, these doughs also exhibit poor extrudability, which limits the use of extrusion tools for creating shapes as intended by the user. Therefore, developments have been made to provide for modeling compounds that retain their softness and flexibility without drying out too quickly.

Further, many modeling play compounds are pre-packaged prior to handling by the end user. Such pre-packaging requires additional precautions to ensure that the product remains soft and flexible during storage and transportation. Therefore, there remains a need to provide for a dough-like play compound that can be formulated by the end user themselves at a point of use. Further, allowing for the user to make their own moldable play compound provides an opportunity to spark creativity and learning.

Conventional modeling compounds rely on the element of heat to produce soft, flexible textures, which resist retrogradation and hardening over time. For example, high amylose starch can be gelatinized by steam jet cooking at 140° C. The hydration process in presence of heat produces a change in the structure of the starch granule, where the starch-starch molecular interactions are disrupted and replaced by starch-water interactions. When an aqueous starch dispersion is heated, gelatinization occurs, wherein the starch granules absorb water and hydrate, producing a viscous hydrocolloidal solution. The absorption of water, which acts as a plasticizer, and formation of hydrogen bonding with water decreases the number of and size of crystalline regions of starch granules. The gelatinization contributes to the soft, flexible texture, and low viscosity of the modeling compound to resist retrogradation and hardening over time.

However, there remains a need to provide dough-like moldable play compounds which do not require the application of heat to provide soft, flexible, and pliable play compounds. Particularly for the ease and safety of the end user, eliminating or reducing the need for heating of the compounds provides a distinct advantage over current modeling compounds.

Accordingly, it is an objective of the claimed invention to develop a composition which can be formed into a dough-like modeling play compound by a user by adding a solvent to the composition, wherein the user determines the time at which to manufacture the moldable play compound.

A further object of the invention is to provide a dough-like moldable play compound which can be made without the application of heat or need for baking.

A further object of the invention is to provide a kit with at least one powder pre-mix composition and a solvent for forming a moldable play compound.

An even further object of the invention is to provide methods for making and using a moldable play compound formed by combining a powder pre-mix composition and a solvent.

Other objects, advantages and features of the present invention will become apparent from the following specification.

### SUMMARY OF PREFERRED EMBODIMENTS

A preferred embodiment is a powder pre-mix composition comprising a binding agent, a salt, and a humectant; wherein the powder pre-mix composition forms a moldable play compound when combined with a solvent.

A preferred embodiment is a moldable play compound comprising a binding agent, a salt, a humectant, and a solvent. In a preferred embodiment, the solvent comprises water.

Still a further preferred embodiment is a kit comprising powder pre-mix composition comprising a binding agent, a salt, and a humectant; wherein the powder pre-mix composition forms a moldable play compound when combined with a solvent.

Yet another preferred embodiment is a method of making a moldable play compound comprising the steps of combining a powder pre-mix composition comprising a binding agent, a salt, a humectant, and a solvent; applying an agitating force to cause the mixing of the pre-mix composition and the solvent for a period of time so as to cause the moldable play compound to be formed.

Still another preferred embodiment is a method of using a moldable play compound comprising the steps of mixing a powder pre-mix composition comprising a binding agent, a salt, and a humectant, with a solvent, wherein the mixing forms the moldable play compound; and molding the play compound.

An advantage of the preferred embodiments is to provide a powder pre-mix composition which can be combined with a solvent to form a moldable play compound at a point of use. It is an advantage of the present invention that the moldable play compound can be formed without the application of heat and may be manufactured by the user.

While multiple embodiments are disclosed, still other embodiments of the present invention will become apparent to those skilled in the art from the following detailed description, which shows and describes illustrative embodiments of the invention.

### DETAILED DESCRIPTION OF THE PREFERRED EMBODIMENTS

The present disclosure relates to dough-like play compounds, particularly, a powder pre-mix composition, as well as kits containing the powder pre-mix composition with a solvent, and methods of making and using the same. The play compounds have many advantages over existing moldable play compounds. For example, the moldable play compounds can be formed without the use of external heat sources. Further, the moldable play compounds can be formulated by the user, providing a user with a source of entertainment and mental stimulation. The methods disclosed herein further provide an interactive system for the user.

The preferred embodiments are not limited to a particular modeling clay, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include singular and plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

### Definitions

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring techniques and equipment, with respect to any quantifiable variable, including, but not limited to, mass, volume, concentration, viscosity, time, and distance. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. Whether or not modified by the term “about,” the claims include equivalents to the quantities.

The compositions, kits, and methods of the present invention may comprise, consist essentially of, or consist of the components and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

The term “hard surface” refers to a solid, substantially non-flexible surface such as a countertop, tile, floor, wall, panel, window, plumbing fixture, kitchen and bathroom furniture, appliance, engine, circuit board, and dish. Hard surfaces may include for example, health care surfaces and food processing surfaces.

The terms “invention” or “present invention” as used herein are not intended to refer to any single embodiment of the particular invention but encompass all possible embodiments as described in the specification and the claims.

As used herein, the terms “moldable play compound” or “modeling compound” refers to flexible compounds that can be used for molding, extruding, or sculpting shapes or figures. As used herein, “moldable play compound” and “modeling compound” are used interchangeably.

As used herein, the phrases “objectionable odor,” “offensive odor,” or “malodor,” refer to a sharp, pungent, or acrid odor or atmospheric environment from which a typical person withdraws if they are able to.

The term “or” is synonymous with “and/or” and means any one member or combination of members of a particular list.

The term “play” can be used herein as an adjective, a verb, a noun, or any other suitable part of speech given proper context. As an adjective, “play” means relating to an activity engaged in for enjoyment and recreation, especially by children. As a verb, “to play” means to engage in a game or activity for enjoyment or recreation. As a noun, “play” means an activity engaged in for enjoyment and recreation. For example, a play compound can be a moldable, moist, soft, and pliable substance used by children for enjoyment and recreation.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” refers to a molecule having surface activity, including wetting agents, dispersants, emulsifiers, detergents, and foaming agents, and the like. It is understood to be inclusive of the use of a single surfactant or multiple surfactants.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The following embodiments are described in sufficient detail to enable those skilled in the art to practice the invention however other embodiments may be utilized. Mechanical, procedural, and other changes may be made without departing from the spirit and scope of the invention. Accordingly, the scope of the invention is defined only by the appended claims, along with the full scope of equivalents to which such claims are entitled.

Powder Pre-Mix Composition

The powder pre-mix composition is provided in a powder form which is pre-mixed. In embodiments, the powder pre-mix composition is anhydrous and substantially free of water. In preferred embodiments, the powder pre-mix composition does not contain any water.

In an embodiment, the powder pre-mix composition comprises a binding agent. The binding agent serves as a base component to the powder pre-mix composition. Exemplary binding agents that can be included in the composition comprise wheat flour, rye flour, rice flour, tapioca flour, corn starch, or a combination thereof. In other embodiments, the binding agent is selected from the group consisting of wheat flour, rice flour, tapioca flour and corn starch. In a preferred embodiment, the binding agent is wheat flour. In a similar embodiment, the binding agent is corn starch. In another aspect, the powder pre-mix composition may include two or more binding agents. In some aspects, the powder pre-mix composition comprises wheat flour and corn starch.

In an aspect, the powder pre-mix compositions include from about 5 wt-% to about 80 wt-% of binding agent, preferably from about 15 wt-% to about 75 wt-% of binding agent, or most preferably from about 20 wt-% to about 65 wt-% of binding agent. In a further embodiment, when more than one binding agent is present in the composition, the compositions include from about 5 wt-% to about 30 wt-% of each binding agent present, preferably from about 7 wt-% to about 20 wt-% of each binding agent present, or most preferably from about 10 wt-% to about 17 wt-% of each binding agent present. In embodiments where two binding agents are present, the binding agents are preferably present in the composition in a ratio of about 2:1 to 1:2, or most preferably in a ratio of about 1:1. In addition, without being limited according to the invention, all ranges recited are inclusive of the numbers defining the range and include each integer within the defined range.

The powder pre-mix composition may further comprise a salt. Any common salt that is soluble in water and is non-toxic may be employed. The salt can reduce the amount of water needed for hydration of the binding agent. Further, in embodiments, the salt can provide antimicrobial properties to the composition. Exemplary salts that may be included in the composition comprise sodium chloride, potassium chloride, calcium chloride, or a combination thereof. In preferred embodiments, the salt comprises sodium chloride.

In an aspect, the powder pre-mix compositions include from about 25 wt-% to about 60 wt-% of salt, preferably from about 27 wt-% to about 50 wt-% of salt, and most preferably from about 30 wt-% to about 45 wt-% of salt. In addition, without being limited according to the invention, all ranges recited are inclusive of the numbers defining the range and include each integer within the defined range.

The powder pre-mix composition may further comprise a humectant. A humectant is a substance that promotes moisture retention. Humectants can also reduce brittleness of the moldable play compound and slow drying to increase working time. Some humectants may also act as a plasticizer to increase the plasticity of the moldable play compound. Exemplary humectants that may be included in the composition comprise mineral oil, a glycol, a polyol, glycerin, sorbitol, polyethylene glycol, or a combination thereof. In preferred embodiments, the humectant comprises a mineral oil. Exemplary mineral oils that can be used are commercially available from a number of sources. An example of a commercially available mineral oil includes those available under the trademark BLANDOL®, a white mineral oil by Sonneborn. In other embodiments, the humectant comprises glycerin and/or sorbitol.

In an aspect, the powder pre-mix compositions include from about 2 wt-% to about 25 wt-% of humectant, preferably from about 4 wt-% to about 20 wt-% of humectant, or most preferably from about 5 wt-% to about 18 wt-% of humectant. In addition, without being limited according to the invention, all ranges recited are inclusive of the numbers defining the range and include each integer within the defined range.

The powder pre-mix composition may further comprise an optional silica and/or silicone compound. The silica and/or silicone compound provides the moldable play compound with a smooth consistency, as well as builds body and dimension to the moldable play compound. Further, the silica and/or silicone compounds prolong moisture retention of the moldable play compound and prevent premature drying. Examples of suitable silica and silicone compounds comprise a polydimethyl siloxane, silica, dimethicone/vinyl dimethicone crosspolymer and silica, or a combination thereof. In embodiments, the silica and/or silicone compound is used to treat the binding agent prior to combining with the remainder of the components of the powder pre-mix composition.

In an aspect, the powder pre-mix compositions include from about 0 wt-% to about 40 wt-% of the silica and/or silicone, from about 4 wt-% to about 35 wt-% of the silica and/or silicone, or from about 5 wt-% to about 30 wt-% of the silica and/or silicone. In addition, without being limited according to the invention, all ranges recited are inclusive of the numbers defining the range and include each integer within the defined range.

The powder pre-mix composition may further comprise an optional acid or salt thereof. In embodiments, the acid comprises tartaric acid or a salt thereof. Tartaric acid or a salt thereof may be employed in the composition for providing uniformity to the composition. The tartaric acid or salt thereof provides the benefits of building volume, stability, and dimension to the moldable play compound.

In an aspect, the powder pre-mix compositions include from about 0 wt-% to about 10 wt-% of the tartaric acid or salt thereof, preferably from about 0.5 wt-% to about 7 wt-% of the tartaric acid or salt thereof, or most preferably from about 1 wt-% to about 5 wt-% of the tartaric acid or salt thereof. In addition, without being limited according to the invention, all ranges recited are inclusive of the numbers defining the range and include each integer within the defined range.

The binding agent may be further treated with the silica and/or silicone component prior to combining with the salt, the humectant, and the optional tartaric acid. In preferred embodiments, the binding agent may be even further treated with one or more additional humectant(s). The one or more additional humectant(s) comprise a mineral oil, a glycol, a polyol, glycerin, sorbitol, polyethylene glycol, or a combination thereof. Preferably, the binding agent may be treated with both mineral oil and glycerin. In embodiments where the binding agent is treated with one or more additional humectant(s), the binding agent to the one or more additional humectant(s) are present in a weight ratio of from about 3:1 to about 12:1, from about 4:1 to about 10:1, or from about 4:1 to about 8:1.

The powder pre-mix composition may further comprise additional additives such as a preservative, a surfactant, a fragrant, glitter, small plastic shapes such as hearts, stars and the like, a colorant such as a suitable color pigment, combination of color pigments, and/or a luminescent. Any one or more of the ingredients may provide a visual and/or a tactile effect. Tactile effects affect how an object feels to a person when touching the object. Visual effects affect how an object appears to a person when looking at the object, and can include the means for eliciting three-dimensional stereoscopic illusions. Non-limiting examples of other visual effects include changing the color of an object; and increasing or decreasing color contrast between adjacent objects.

The powder pre-mix composition is provided so that when combined with a solvent, the powder-premix composition forms a dough-like moldable play compound. In a preferred embodiment, the solvent is water. In embodiments, the water is provided as cold water or at ambient temperature. In preferred embodiments, the moldable play compound is formed without the application of heat.

Ratio(s) of each provided ingredient of the play compound are linked to a particular composition of the play compound which will be provided. For example, if there is a greater quantity of powder added to an amount of liquid, then the play compound will have greater density and/or other characteristic. If a smaller quantity of powder is added to the amount of liquid, the play compound will have a lower viscosity and/or other characteristic. In embodiments, the ratio of powder to water is in the range of from about 1:1 to about 5:1, in preferred embodiments, the ratio of powder to water is in the range of from about 2:1 to about 4:1.

Moldable Play Compound

The invention also provides for pre-made dough-like moldable play compounds. The moldable play compound is a material of the type for use in play and/or crafts and can be non-toxic. Some play compounds of this type conventionally include a starch binding agent and water, however, have been found to dry quickly. In embodiments, the moldable play compound can be odorless or does not have an objectionable odor, or a particular odor can be added to the same. The moldable play compound can be formed of a particular color. The moldable play compound typically feels solid but soft when touched by a user's hands. The moldable play compound can crumble easily if pressure is applied to break the compound apart, however, will mold into various shapes as intended by the user when compressed.

The play compound can be formed from a plurality of different powder types and a solvent, such as water. The different powder types can be selectively used alone or in combination to form a particular moldable play compound when combined with the solvent. The powders may differ in terms of any or any combination of color; consistency; ingredients; additional additives such as glitter, small plastic hearts or stars, and the like. Ingredients of the powder include a pre-mix powder composition comprising a binding agent, a salt, a humectant, and optionally a silica and/or silicone, tartaric acid or a salt thereof, or a combination thereof; a colorant, such as a suitable color pigment, combination of color pigments, and/or a luminescent; a phosphate such as sodium hydrogen phosphate; an ethanol; and/or an acetate such as sodium dehydroacetate. Any one or more of the ingredients may provide a visual and/or a tactile effect. Tactile effects affect how an object feels to a person when touching the object. Visual effects affect how an object appears to a person when looking at the object. Non-limiting examples of visual effects include changing the color of an object; increasing or decreasing color contrast between adjacent objects; and increasing or decreasing an object's flexibility.

Ratio(s) of each provided ingredient of the moldable play compound are linked to a particular composition of the play compound which will be provided. For example, if there is a greater quantity of powder added to an amount of liquid, then the play compound will have greater density and/or other characteristic. If a smaller quantity of powder is added to the amount of liquid, the play compound will have a lower viscosity and/or other characteristic. Each of the compounds can be linked to a particular identifiable type or characteristic of the moldable play compound. The specific ingredients or additives contained within the moldable play compound are typically provided in set percentages under factory conditions, however, the composition of the play compound may be later altered by a user with other ingredients and/or additives to make a new play compound with at least some user selected characteristics.

Preferably, the moldable play compound comprises from about 15 w-% to about 40 wt-% water, or more preferably from about 18 wt-% to about 35 wt-% water. In embodiments, the binding agent is present in the moldable play compound in the amount of from about 3 wt-% to 48 wt-%, preferably from about 10 wt-% to about 44 wt-%, or most preferably from about 13 wt-% to about 44 wt-%. In embodiments, the salt is present in the moldable play compound in the amount of from about 17 wt-% to about 48 wt-%, preferably from about 18 wt-% to about 40 wt-%, or most preferably from about 20 wt-% to about 36 wt-%. In embodiments, the humectant is present in the moldable play compound in the amount of from about 1 wt-% to about 20 wt-%, preferably from about 2 wt-% to about 16 wt-%, or most preferably from about 3 wt-% to about 15 wt-%. Optionally, the silica and/or silicone is present in an amount of from about 0 wt-% to about 32 wt-%, preferably from about 2 wt-% to about 28 wt-%, or most preferably from about 3 wt-% to about 24 wt-%. Optionally, the tartaric acid is present in the moldable play compound in the amount of from about 0 wt-% to about 8 wt-%, preferably from about 0.3 wt-% to about 6 wt-%, or most preferably from about 0.6 wt-% to about 4 wt-%. In addition, without being limited according to the invention, all ranges recited are inclusive of the numbers defining the range and include each integer within the defined range.

The binding agent may be further treated with the silica and/or silicone prior to combining with the salt, the humectant, and the optional tartaric acid. The binding agent may be even further treated with one or more additional humectant(s). The one or more additional humectant(s) comprises a mineral oil, a glycol, a polyol, glycerin, sorbitol, polyethylene glycol, or a combination thereof. Preferably, the binding agent may be treated with both mineral oil and glycerin. In embodiments where the binding agent is treated with one or more additional humectant(s), the binding agent to the one or more additional humectant(s) are present in a weight ratio of from about 3:1 to about 12:1, from about 4:1 to about 10:1, or from about 4:1 to about 8:1.

To play with the moldable play compound individually, the play compound can be manipulated by the user's hands to take selected forms such as a soft, flexible, moldable and extrudable form, as well as a compact form. The user will appreciate the moldable play compound, is partially elastic and once moved into a particular shape, has a tendency to stay in that shape until further manipulated by the user. This type of compound and the manipulation of the same can provide entertainment for many hours to the user.

Kits

In an aspect, a kit can be provided to prepare the dough-like moldable play compound. In an aspect, a kit can include at least one powder pre-mix composition for combining with a solvent to form the dough-like moldable play compound. In an embodiment, the powder pre-mix compositions are combined and mixed together prior to adding a solvent.

In an aspect, a powder pre-mix composition can include a binding agent comprising wheat flour, rye flour, rice flour, tapioca flour, corn starch, or a combination thereof; a salt comprising sodium chloride, potassium chloride, calcium chloride, or a combination thereof; a humectant comprising a mineral oil, a glycol, a polyol, glycerin, sorbitol, polyethylene glycol, or a combination thereof; optionally a silica and/or silicone comprising a polydimethyl siloxane, silica, dimethicone/vinyl dimethicone crosspolymer and silica, or a combination thereof; optionally, tartaric acid or a salt thereof; and optionally additional additives.

The binding agent may be further treated with the silica and/or silicone prior to combining with the salt, the humectant, and the optional tartaric acid. The binding agent may be even further treated with one or more additional humectant(s). The one or more additional humectant(s) comprise a mineral oil, a glycol, a polyol, glycerin, sorbitol, polyethylene glycol, or a combination thereof. Preferably, the binding agent may be treated with both mineral oil and glycerin. In embodiments where the binding agent is treated with one or more additional humectant(s), the binding agent to the one or more additional humectant(s) are present in a weight ratio of from about 3:1 to about 12:1, from about 4:1 to about 10:1, or from about 4:1 to about 8:1.

In an aspect, the powder pre-mix compositions include from about 5 wt-% to about 80 wt-% of binding agent, preferably from about 15 wt-% to about 75 wt-% of binding agent, or most preferably from about 20 wt-% to about 65 wt-% of binding agent. In a further embodiment, when more than one binding agent is present in the composition, the compositions include from about 5 wt-% to about 30 wt-% of each binding agent present, preferably from about 7 wt-% to about 20 wt-% of each binding agent present, or most preferably from about 10 wt-% to about 17 wt-% of each binding agent present. In embodiments where two binding agents are present, the binding agents are preferably present in the composition in a ratio of about 2:1 to 1:2, or most preferably in a ratio of about 1:1. In addition, without being limited according to the invention, all ranges recited are inclusive of the numbers defining the range and include each integer within the defined range.

In an aspect, the powder pre-mix compositions include from about 25 wt-% to about 60 wt-% of salt, preferably from about 27 wt-% to about 50 wt-% of salt, and most preferably from about 30 wt-% to about 45 wt-% of salt. In addition, without being limited according to the invention, all ranges recited are inclusive of the numbers defining the range and include each integer within the defined range.

In an aspect, the powder pre-mix compositions include from about 2 wt-% to about 25 wt-% of humectant, preferably from about 4 wt-% to about 20 wt-% of humectant, or most preferably from about 5 wt-% to about 18 wt-% of humectant. In addition, without being limited according to the invention, all ranges recited are inclusive of the numbers defining the range and include each integer within the defined range.

In an aspect, the powder pre-mix compositions may optionally comprise from about 0 wt-% to about 40 wt-% of the silica and/or silicone, preferably from about 4 wt-% to about 35 wt-% of the silica and/or silicone, or most preferably from about 5 wt-% to about 30 wt-% of the silica and/or silicone. In addition, without being limited according to the invention, all ranges recited are inclusive of the numbers defining the range and include each integer within the defined range.

In an aspect, the powder pre-mix compositions may optionally comprise an acid or salt thereof. In an embodiment, the acid comprises tartaric acid or a salt thereof. The powder pre-mix compositions may optionally include from about 0 wt-% to about 10 wt-% of the tartaric acid or salt thereof, preferably from about 0.5 wt-% to about 7 wt-% of the tartaric acid or salt thereof, or most preferably from about 1 wt-% to about 5 wt-% of the tartaric acid or salt thereof. In addition, without being limited according to the invention, all ranges recited are inclusive of the numbers defining the range and include each integer within the defined range.

The powder pre-mix composition may further comprise additional additives such as a preservative, a surfactant, a fragrant, glitter, small plastic hearts or stars and the like, a colorant such as a suitable color pigment, combination of color pigments, and/or a luminescent. Any one or more of the ingredients may provide a visual and/or a tactile effect.

The kit further contains a solvent to combine with the powder pre-mix composition. In preferred embodiments, the solvent is water. The water is combined with the powder pre-mix composition to form a dough. In embodiments, the ratio of powder to water is in the range of from about 1:1 to about 5:1, in preferred embodiments, the ratio of powder to water is in the range of from about 2:1 to about 4:1.

Methods of Making and Using a Dough-Like Moldable Play Compound

The invention further provides for methods of making an using a dough-like moldable play compound which, once formed, has similar qualities of use as an equivalent type of moldable play compound which is made under factory conditions, while allowing the compound to be made by a person in their home environment.

In an embodiment, a method of making a dough-like moldable play compound is provided. The method of making a moldable play compound comprising the steps of combining a quantity of a powder pre-mix composition comprising a binding agent, a salt, and a humectant, with a quantity of solvent, and applying an agitating force to cause the mixing of the pre-mix powder composition and the solvent. The application of agitating force may be for a period of time as to cause the moldable play compound to be formed. In preferred embodiments, the solvent is water. The pre-mix powder may further comprise a silica and/or silicone and/or an acid comprising tartaric acid or a salt thereof, as well as additional additives to provide a visual and/or tactile effect.

The binding agent may be further treated with the silica and/or silicone prior to combining with the salt, the humectant, and the optional tartaric acid. The binding agent may be even further treated with one or more additional humectant(s). The one or more additional humectant(s) comprise a mineral oil, a glycol, a polyol, glycerin, sorbitol, polyethylene glycol, or a combination thereof. Preferably, the binding agent may be treated with both mineral oil and glycerin. In embodiments where the binding agent is treated with one or more additional humectant(s), the binding agent to the one or more additional humectant(s) are present in a weight ratio of from about 3:1 to about 12:1, from about 4:1 to about 10:1, or from about 4:1 to about 8:1.

The methods may provide for a powder pre-mix composition that is formed under factory conditions to include the ingredients which are required in predefined percentages, wherein the powder pre-mix composition is then provided to a user to be used in conjunction with the solvent. In an aspect, the user is provided with instructions relating to the ratio of the powder to water for producing the moldable play compound. In an embodiment, a range of ratios are provided, and the user can select which ratio to use at the time of manufacture. In embodiments, the ratio of the powder pre-mix composition to solvent is in the range of from about 1:1 to about 5:1, in preferred embodiments, the ratio of powder to water is in the range of from about 2:1 to about 4:1.

In some embodiments, a specific mixing container is provided and the container has marked thereon one or more levels which indicate the quantity of solvent and/or powder which should be poured into the container in order to form a suitable moldable play compound with specific characteristics.

In other embodiments, the method includes an apparatus to aid in the formation of the moldable play compound, said apparatus including a base, a cavity and mixing means which, when operated, cause agitation and mixture of a pre-mix powder composition and a solvent located in the cavity, to form the moldable play compound. In an embodiment, the apparatus base includes the cavity or receives an item in which the cavity is formed, and the mixing means includes an arm which is movable with respect to the base. In one embodiment the arm is rotatable.

In a further embodiment, the arm includes at least one, or a number of portions which are located with respect to the cavity so as to cause an agitating, and hence mixing, effect on the solvent and pre-mix powder composition which are located in the cavity at that time. In an embodiment, the arm includes one or more ports through which the powder can be poured to introduce the same for mixing with the solvent in the base. In one embodiment the powder is introduced as the arm is moved. The apparatus may further include one or more capsules into which the formed moldable play compound can be placed and stored prior to subsequent use.

In a further aspect of the invention there is provided apparatus for use in the formation of a moldable play compound by mixing a pre-mix powder and water, said apparatus including a base, a cavity included in, or received by, the base in which the powder and liquid are mixed and wherein a mixing means is provided in a form such that relative rotational movement of the base and at least an arm of the mixing means causes agitation and mixing of the powder and liquid together to form the moldable play compound. In embodiments, the relative rotational movement is caused by the application of a manual movement force on a handle of the mixing means located externally of the cavity. Alternatively, a powered movement means can be provided.

Typically, the handle extends through an aperture in a lid and into the cavity to perform the mixing and the lid prevents spillage of the solvent and/or powder as the same are mixed to form the play compound. In an aspect, the lid is selectively removable from the cavity to allow access to be gained to introduce the solvent and powder and/or remove the formed play compound.

In one embodiment the movement means are provided as an arm which is rotatably movable with respect to the base about a substantially central axis of the cavity. In a further embodiment, the arm includes at least one portion which is located with respect to the base to cause an agitating, and hence mixing, effect on the solvent and ingredients which are located in the base at that time. In one embodiment the said ingredients are provided in a powder form which is premixed.

In an embodiment the arm includes one or more ports through which the powder can be poured to introduce the same for mixing with the solvent in the base. In one embodiment the powder is introduced as the arm is moved and thereby allows the powder to be introduced to the liquid in a manner which reduces the risk of lumping. In an aspect, the apparatus may include one or more capsules into which the formed moldable play compound can be placed and stored prior to subsequent use.

In one embodiment the powder pre-mix composition is provided in a predetermined quantity such that when the user adds the full quantity to a predetermined quantity of solvent, the user can be confident that a moldable play compound with predetermined characteristics will be formed. In an aspect, the powder is provided to a user and the user mixes the powder with the solvent to form a moldable play compound.

In a further embodiment, the methods include a plurality of different powder types which can be selectively used alone or in combination to form a particular moldable play compound. In an aspect, the powders may differ in terms of any combination of colour, consistency, ingredients, and additional components such as glitter, and the like.

In a further aspect of the invention there is provided a play compound said play compound formed by adding a powder with a solvent into a cavity of a container, said powder including a plurality of components required to form the moldable play compound and mixing the powder and solvent for a period of time sufficient to cause the play compound to be formed. In an embodiment, the mixing is performed by a person grasping and moving, typically by shaking, the container. In a further embodiment, the mixing is performed by a person operating a mixing means.

The invention further provides for methods of using a dough-like moldable play compound comprising mixing a quantity of powder pre-mix composition comprising a binding agent, a salt, a humectant, with a quantity of solvent. The powder pre-mix may further comprise a silica and/or silicone, tartaric acid or a salt thereof, or a combination thereof. In embodiments, additional additives may be added to provide a visual and/or tactile effect.

The moldable play compound may be used using an extrusion apparatus to form a variety of shapes or three-dimensional structures on a substrate. In embodiments, the moldable play compounds can be used to form a variety of shapes (such as geometric and non-geometric shapes, linear and non-linear shapes, etc.). The moldable play compounds may be molded with tools, by hand, by molds or using extrusion devices to form a variety of shapes. In addition, the moldable play compound can be used in a pen-like device or any device capable of applying the moldable play compound onto a surface, such as paper or a hard surface, to produce art like effects.

In some embodiments, the moldable play compound can be adhered onto a substrate and allowed to remain undisturbed for a suitable period of time to allow the moldable play compound to dry and adhere onto the substrate. In some embodiments, the moldable play compound can function as an adhesive. In some aspect, the moldable play compound has an adhesion property permitting the moldable play compound to adhere onto a variety of substrates or to be glued together to form a three-dimensional structure.

In additional embodiments, the moldable play compound can be manipulated using an applicator. Examples of applicators include stampers (for stamping patterns into compound), a roller cutter, sculpting tools, a squeegee (to squeegee the moldable play compound into a recessed/embossed design or to clean a compound away from a surface), a pattern roller, or a pen-like device. In some aspects, the moldable play compound can be extruded using an extruder, a caulk gun style extruder (such as a pump action extruder) or a half mold press extruder to squeeze and mold various shapes such as flowers, butterflies, hearts, charms, and the like.

In further embodiments, the moldable play compound is stored within a storage means or a storage container in dough form until the play compound is selectively removed for play.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

Multiple exemplary pre-mix compositions were prepared according to the Table 1 below.

TABLE 1
Exemplary Pre-Mix Powder Formulas

| Ingredients | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Component | Exemplary | | | | | | | | |
| Category | Species | % w/w | | | | | | | |
| Binding | Wheat Flour | 46 | 46.9 | 43.4 | 50.5 | 0 | 27.08 | 20 | 15 |
| Agent | | | | | | | | | |
| Salt | Sodium | 42.6 | 39.6 | 39.6 | 33 | 35 | 36.46 | 36 | 40 |
| | Chloride | | | | | | | | |
| Silica | Polydimethyl | 7 | 0 | 0 | 0 | 0 | 0.00 | 0 | 5 |
| | Siloxane | | | | | | | | |
| Acid | Tartaric acid | 4.4 | 3.5 | 3 | 3.3 | 3 | 3.13 | 4 | 3 |
| Humectant | Mineral Oil | 0 | 10 | 14 | 13.2 | 16 | 0.00 | 10 | 7 |
| Binding Agent | Corn Starch | 0 | 0 | 0 | 0 | 23 | 0.00 | 0 | 15 |
| Silica | Silica | 0 | 0 | 0 | 0 | 23 | 20.83 | 0 | 0 |
| Silica | Dimethicone/ | 0 | 0 | 0 | 0 | 0 | 0 | 30 | 15 |
| | vinyl | | | | | | | | |
| | dimethicone | | | | | | | | |
| | crosspolymer | | | | | | | | |
| | silica | | | | | | | | |

The exemplary pre-mix powder formulas described in the above table were mixed with water as an exemplary solvent to evaluate their ability to form a play compound and the properties of that play compound to ensure appropriate texture, appearance, and moldability. The powder to water ratios (weight basis) for the exemplary formulas are provided below in Table 2.

TABLE 2
Exemplary Tested Powder Pre-Mix to Water Ratios

| | | Ex. | Ex. | Ex. | Ex. | Ex. | Ex. | | Ex. |
|---|---|---|---|---|---|---|---|---|---|
| Ratio | | 1 | 2 | 3 | 4 | 5 | 6 | Ex. 7 | 8 |
| Pow- | Water | 15:7 | 15:5 | 15:5 | 15:5 | 15:5 | 15:5 | 15:7 | 15:5 |
| der | | | | | | | | | |
| Pow- | Water | 15:5 | | | | 15:4.5 | | 15:5.5 | |
| der | | | | | | | | | |

The play compounds made by the combination of the powder pre-mix and water were moldable, had a doughy appearance and a doughy texture.

### Example 2

Additional exemplary pre-mix compositions were prepared according to the Table 3 below.

TABLE 3
Additional Exemplary Pre-Mix Powder Formulas

| Ingredients | | | |
|---|---|---|---|
| Component | | Ex. 9 | Ex. 10 |
| Category | Exemplary Species | % w/w | |
| Binding | Wheat Flour (treated with | 52.5 | 51.5 |
| Agent | glycerin and mineral oil) | | |
| Salt | Sodium Chloride | 36 | 36 |
| Acid | Tartaric acid | 3.5 | 3.5 |
| Humectant | Glycerin | 8 | 3 |
| Humectant | Sorbitol, 70% | 0 | 6 |

The additional exemplary pre-mix powder formulas described in the above table were mixed with water as an exemplary solvent to evaluate their ability to form a play compound and the properties of that play compound to ensure appropriate texture, appearance, and moldability. The powder to water ratios (weight basis) for the additional exemplary formulas are provided below in Table 4.

TABLE 4
Exemplary Tested Powder Pre-Mix to Water Ratios

| Ratio | | Ex. 9 | Ex. 10 |
|---|---|---|---|
| Powder | Water | 15:5 | 19:5 |
| Powder | Water | | 19.32:5.68 |
| Powder | Water | | 15:5 |

The play compounds made by the combination of the powder pre-mix and water were moldable, had a doughy appearance and a doughy texture. The treatment of the binding agent with glycerin and mineral oil beneficially provided superior properties to the play compound including further retention of moisture of the play compounds.

### Example 3

Additional exemplary pre-mix compositions were prepared according to the Table 5 below.

TABLE 5
Additional Exemplary Pre-Mix Powder Formulas

| Ingredients | | |
|---|---|---|
| Component | | Ex. 9 |
| Category | Exemplary Species | % w/w |
| Binding | Wheat Flour (treated with | 56.5 |
| Agent | glycerin and mineral oil) | |
| Salt | Sodium Chloride | 36 |
| Humectant | Glycerin | 7.5 |

The additional exemplary pre-mix powder formulas described in the above table were mixed with water as an exemplary solvent to evaluate their ability to form a play compound and the properties of that play compound to ensure appropriate texture, appearance, and moldability. The play compounds made by the combination of the powder pre-mix and water were moldable, had a doughy appearance and a doughy texture. The treatment of the binding agent with glycerin and mineral oil beneficially provided superior properties to the play compound including further retention of moisture of the play compounds.

The above specification provides a description of the compositions, manufacture and use of the disclosed compositions and methods. The present disclosure is not to be limited to the particular embodiments described herein. Since many embodiments can be made without departing from the spirit and scope of the invention, the invention resides in the claims.

What is claimed is:

1. A powder pre-mix composition, comprising:
between 5 wt. % and about 80 wt. % of a binding agent; wherein the binding agent comprises wheat flour, corn starch, or a combination thereof;
a salt; and
between 2 wt. % and 25 wt. % of a humectant; wherein the humectant comprises mineral oil, glycerin, sorbitol, or a combination thereof;
wherein the powder pre-mix composition forms a moldable play compound when combined with a solvent.

2. The composition of claim 1, wherein the binding agent comprises wheat flour and corn starch in a ratio of from about 2:1 to about 1:2.

3. The composition of claim 1, wherein the salt comprises sodium chloride and is present in the composition in an amount of from about 25 wt-% to about 60 wt-%.

4. The composition of claim 1, wherein the composition further comprises a silica and/or silicone comprising polydimethyl siloxane, silica, dimethicone/vinyl dimethicone cross polymer and silica, or a combination thereof, and is present in the composition in an amount of from about 2 wt-% to about 40 wt-%.

5. The composition of claim 1, wherein the binding agent is further treated with one or more additional humectants comprising glycerin, mineral oil, or a combination thereof.

6. The composition of claim 1, wherein the composition further comprises from about 0.5 wt-% to about 7 wt-% of tartaric acid or a salt thereof.

7. The composition of claim 1, wherein the composition is substantially free of water.

8. The composition of claim 1, wherein the solvent is water.

9. The composition of claim 8, wherein a ratio of the powder pre-mix composition to water is between about 1:1 to 5:1.

10. A moldable play compound, comprising:
a binding agent;
a salt;
a humectant; and
a solvent.

11. The play compound of claim 10, wherein the solvent comprises water.

12. The play compound of claim 10, wherein the binding agent comprises wheat flour, corn starch, or a combination thereof, wherein the salt comprises sodium chloride, and wherein the humectant comprises mineral oil, glycerin, sorbitol, or a combination thereof; wherein the play compound further comprises tartaric acid or a salt thereof, a silica and/or silicone comprising polydimethyl siloxane, silica, dimethicone/vinyldimethicone cross polymer, or silica, or a combination thereof; wherein the play compound further comprises an additive to provide a visual and/or tactile effect, wherein the additive comprises a preservative, a surfactant, a fragrant, a glitter, small plastic shapes, a colorant, or a combination thereof; and wherein the binding agent is further treated with one or more additional humectants comprising glycerin, mineral oil, or a combination thereof.

13. A kit comprising the powder pre-mix composition of claim 1, instructions for play, and one or more additives to provide a visual and/or tactile effect, wherein the one or more additives comprise a preservative, a surfactant, a fragrant, a glitter, small plastic shapes, a colorant, or a combination thereof.

14. The kit of claim 13, wherein the binding agent comprises wheat flour, rye flour, rice flour, tapioca flour, corn starch, or a combination thereof; wherein the salt comprises sodium chloride, potassium chloride, calcium chloride, or a combination thereof; wherein the humectant comprises a mineral oil, a glycol, a polyol, glycerin, sorbitol, polyethylene glycol, or a combination thereof.

15. The kit of claim 13, wherein the powder pre-mix composition further comprises tartaric acid or a salt thereof.

16. The kit of claim 13, wherein the binding agent is further treated with one or more additional humectants comprising glycerin, mineral oil, or a combination thereof.

17. A method of making a moldable play compound, comprising:
combining a powder pre-mix composition comprising a binding agent, a salt, a humectant, and a solvent;
applying an agitating force to cause the mixing of the pre-mix composition and the solvent for a period of time so as to cause the moldable play compound to be formed.

18. The method of claim 17, wherein the powder is provided to a user and the user mixes the powder with the solvent, and wherein the solvent comprises water.

19. The method of claim 17, wherein the moldable play compound is formed without the application of heat.

20. A method of using a moldable play compound, comprising:
mixing a powder pre-mix composition comprising a binding agent, a salt, and a humectant, with a solvent, wherein the mixing forms the moldable play compound; and
molding the play compound.

21. The method of claim 20, wherein additional additives may be added to provide a visual and/or tactile effect.

22. The method of claim 20, wherein the molding of the play compound is with tools, by hand, by molds, or using an extrusion device.

23. The method of claim 20, wherein the play compound is stored within a storage container in dough form until the play compound is selectively removed for play.

24. The method of claim 20, wherein the moldable play compound is formed without the application of heat.
